(19) United States
(12) Patent Application Publication
(10) Pub. No.: US 2015/0322231 A1
(43) Pub. Date: Nov. 12, 2015

(54) Method for Recycling Mixed Waste Carpet To Manufacture a Polymer Modified Aggregate for Hot Mix Asphalt Applications

(71) Applicant: Charles A. WILSON, Needham, MA (US)

(72) Inventor: Charles A. WILSON, Needham, MA (US)

(21) Appl. No.: 14/705,578

(22) Filed: May 6, 2015

Related U.S. Application Data
(60) Provisional application No. 61/989,253, filed on May 6, 2014.

(51) Int. Cl. C08J 11/06; C08K 3/26

(52) U.S. Cl. CPC C08J 11/06; C08K 3/26; C08J 2353/02; C08J 2495/00; C08K 2003/265

(57) ABSTRACT

The present disclosure relates to a method and apparatus for preparation of recycled carpet scrap containing elevated levels of an inorganic filler. The disclosure also relates to associated methods of melt processing to control and monitor the level of inorganic filler, as well as compositions of the recycled carpet scrap as an additive in hot mix asphalt.

### CROSS-REFERENCE TO RELATED APPLICATIONS

This application claims the benefit of U.S. Provisional Patent Application Ser. No. 61/989,253, filed on May 6, 2014, which is fully incorporated herein by reference.

### FIELD

The present disclosure relates to a method of recycling mixed, synthetic carpet to manufacture a polymer modified aggregate (PMAG) for use as a partial or full substitute of mineral aggregate in a hot mix asphalt application.

### BACKGROUND

Each year, approximately five billion pounds of carpet are discarded into landfills across the United States due to the difficulty in recycling carpet. Some of the challenges that make carpet difficult to recycle include:

1. Separating carpet into its individual components due to its durable construction

2. Carpet is manufactured from a variety of polymer materials that cannot be easily mixed or processed together without additional additives and/or compatibilizers

For example, carpet and carpet tiles can include the use of the following polymer materials for face fiber and backing (face fiber/backing). The face fiber and backing are then typically adhered together by styrene-butadiene rubber (SBR) latex containing calcium carbonate (CaCO_{3) filler.}

1. Nylon 6/Polypropylene

2. Nylon 6-6/Polypropylene

3. Polyester/Polypropylene

4. Polypropylene/Polypropylene

5. Polytrimethylene Terephthalate/Polypropylene

6. Nylon 6/Polyvinyl Chloride

7. Nylon 6-6/Polyvinyl Chloride

8. Nylon 6/EVA

9. Nylon 6-6/EVA

10. Nylon 6/LDPE

11. Nylon 6-6/LDPE

Tables 1, 2, and 3 exhibit the percentage of face fiber, backing, filler, and SBR latex adhesive which itself contains filler for residential, commercial, and tile carpets:

TABLE 1
Residential Carpet - Carpet Components
by % Weight Per Yard of Carpet

| | % Wt. Face | % Wt. | % Wt. | |
|---|---|---|---|---|
| Face | Fiber | Backing | CaCO3 | % SBR |
| Fiber/Backing | Per Yard | Per Yard | Per Yard | Per Yard |
| Nylon 6/Poly- | 35-60% | 15% | 40.0-22.0% | 10.0-3.0% |
| propylene | | | | |
| Nylon 6-6/Poly- | 35-60% | 15% | 40.0-22.0% | 10.0-3.0% |
| propylene | | | | |
| Polyester/Poly- | 35-60% | 15% | 40.0-22.0% | 10.0-3.0% |
| propylene | | | | |
| Polypropylene/Poly- | 35-60% | 15% | 40.0-22.0% | 10.0-3.0% |
| propylene | | | | |
| PTT/PP | 35-60% | 15% | 40.0-22.0% | 10.0-3.0% |

TABLE 2
Commercial Carpet - Carpet Components
by % Weight Per Yard of Carpet

| | % Face | % | % | |
|---|---|---|---|---|
| Face | Fiber | Backing | CaCO3 | % SBR |
| Fiber/Backing | Per Yard | Per Yard | Per Yard | Per Yard |
| Nylon 6/PP | 35-45% | 15% | 40-34% | 10.0-6.0% |
| Nylon 6-6/PP | 35-45% | 15% | 40-34% | 10.0-6.0% |
| Polypropylene/PP | 35-45% | 15% | 40-34% | 10.0-6.0% |

TABLE 3
Carpet Tiles - Carpet Components by % Weight Per Yard of Carpet

| Face Fiber/Polymer Backing | % Face Fiber | % Backing Per Yard |
|---|---|---|
| Polymers (LDPE, PVC, EVA) | Per Yard | (polymers & fiberglass) |
| Nylon 6/LDPE, EVA, PVC | 20-30 | 80-70 |
| Nylon 6-6/LDPE, EVA, PVC | 20-30 | 80-70 |
| Specified Percentage #1 | 20.0 | 80.0 |
| Specified Percentage #2 | 25.0 | 75.0 |
| Specified Percentage #3 | 30.0 | 70.0 |

Since face fiber can vary in length in a stream of waste carpet, therefore the percent weight of face fiber per yard in each carpet is also going to vary. This directly affects the amount of calcium carbonate and SBR weight percentage in each yard of carpet as seen in Table 1 and Table 2. The primary and secondary backings are light enough where they essentially remain constant. This will play a role when discussing the use of carcasses in this process discussed herein.

These above materials are non-exclusive and other polymer materials may be utilized for the backing and face fibers as well. Note that polypropylene face fiber and polypropylene backings are different types of polypropylene polymer. The mechanical properties between the face fiber and backing are very different such that the melt strength of the face fiber is very high so that it is capable of being spun and is soft to the touch. The backing has a low melt temperature and an extremely low melt index for stronger mechanical properties as it is the backbone of the carpet that gives the carpet its durability.

### Carpet Collection Problems

When post-consumer and/or post-industrial carpets are collected for recycling, several different carpet types can be mixed together, many of which presently have relatively little or no value. Collectors mainly look for nylon fiber, as its market value is relatively high in comparison to other fibers. A problem that collectors encounter is that carpet with nylon and polyester face fibers cannot be differentiated in the field. Polyester fibers presently have little monetary value and subsequently these carpets must be disposed of at an additional cost to the collector. As polyester face fibers are becoming more prevalent in the carpet industry, collectors are finding more polyester face fiber carpet in their recycling facilities. As of 2013, 30% of all residential carpet collected for recycling incorporates polyester face fiber. Nylon face fiber can be sheared and sold for polymer pelletization. The fibers are baled and sent to compounding facilities where the nylon is pelletized and additives are compounded into the nylon for additional polymer performance. What is left behind is called the carpet “carcass”. The carcass has three main materials bonded together:

1. Face Fiber

2. Calcium Carbonate and SBR

3. Backing—Primary and Secondary

Backing is fabric that makes up the back of the carpet, as opposed to the carpet pile or face. In tufted carpet, primary backing is the material that the yarn is stitched through. Secondary backing is added in the finishing process and serves to add strength and dimensional stability to the carpet, and insures the individual tufts are locked in place. A woven synthetic secondary backing, such as woven polypropylene, is laminated to the primary backing in a device on the coater referred to as a marriage roller. A water emulsion synthetic latex, styrene butadiene rubber (SBR), is applied to the tufted primary backing to anchor the tuft's yarn bundles. This process is followed by a second “coat” of this latex compound in order to laminate the secondary backing to the carpet to give it dimensional stability. In manufacturing, a latex compound consisting of styrene butadiene rubber (SBR or SB Rubber) and filler (such as calcium carbonate) is typically used as a pre-coat and as a laminate, although polyurethane is also used.

### Calcium Carbonate and SBR

The carcass has relatively little or no value because separation of these three components with minimal contamination to any one component is extremely difficult and costly. At present, a “mainstream” process to recycle large volumes of carcasses is not understood to exist and subsequently they are sold as a fuel source or disposed of in landfills.

The present disclosure is directed toward a recovery process that can use all or most types of carpets, carcasses and, in some instances, all of the parts of a carpet including the backings, face fibers, binders, adhesives and fillers together without the use of polymer compatibilizers to manufacture a polymer modified aggregate. Reference to carpet herein therefore includes synthetic carpet, synthetic carpet tiles, synthetic area rugs, synthetic broadloom carpet, synthetic tufted carpet, synthetic continuous fiber carpet, and synthetic commercial carpet.

### SUMMARY

The present disclosure is directed at a method for increasing the levels of filler in carpet scrap comprising: (a) supplying carpet scrap containing a polymer backing, polymeric face fibers and a binder containing calcium carbonate, wherein the level of calcium carbonate is present at a level of up to 40.0% by weight per square yard of carpet carcass; (b) introducing the carpet scrap into melt processing equipment and adding additional calcium carbonate, wherein said additional calcium carbonate is supplied as either neat calcium carbonate or calcium carbonate dispersed in a polymeric binder; and (c) melt compounding the mixture in (b) and forming an extrudate of recycled carpet containing greater than 40.0% by weight of calcium carbonate per square yard of carpet to 90.0% by weight of calcium carbonate per square yard of carpet. The carpet scrap may be selected from any general source of carpeting that is targeted for recycling, including by not limited to carpet tiles as well as carpet carcasses.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 illustrates a process flowchart of an embodiment of a carpet sorting procedure;

FIG. 2 illustrates a schematic of a size reduction and particulate retrieval system; and

FIG. 3 illustrates a schematic of a process for compounding mixed waste carpet.

### DETAILED DESCRIPTION

The present disclosure is directed at a recovery or recycling process that modifies and utilizes various carpets, carpet carcasses including backings, face fibers, binders, adhesives and fillers, without the use of a polymer compatibilizer to produce a polymer modified aggregate (PMAG) final product containing relatively higher loadings of calcium carbonate filler. Reference to carpet scrap is reference to any form of carpet that has been recovered from post consumer applications or from waste carpet from post industrial production. A carpet carcass is a reference to a carpet where the face fibers have been sheared, and in particular, a carpet where up to 60.0% by weight of the face fibers have been sheared for recycling/recovery purposes.

### Carpet Recycling Process

The preferred recycling process herein utilizes a single or twin screw extruder to melt compound mixed polymers from waste carpet without the use of a compatibilizer. A compatibilizer is reference to an additive, such as a block copolymer, which is designed to improve the mixing and interaction of the mixed polymer system in which they are introduced. It is also worth noting, as alluded to above, that many synthetic carpets already incorporate up to 40.0% by weight per yard of calcium carbonate, which calcium carbonate is provided within the SBR resin.

This process herein incorporates an additional loading percentage of calcium carbonate and/or SBR. That is, the process herein relates to incorporation of an additional amount of SBR containing calcium carbonate and or the incorporation of additional calcium carbonate to the carpet scrap. With regards to preferred levels, in the case of additional loading of SBR containing calcium carbonate, it is preferred to utilize an SBR/calcium carbonate additive source that itself contains 50.0% wt or more of calcium carbonate. Accordingly, the use of an SBR/calcium carbonate source can be one that contains SBR and 50.0% wt to 95.0% wt calcium carbonate.

In addition, as noted, one may add additional amounts of calcium carbonate to the recycled carpet. In this case, the calcium carbonate is added itself directly to the carpet polymer mixture that is undergoing recycling.

In either case, whether one elects to utilize a SBR/calcium carbonate mixture or calcium carbonate on its own, the present disclosure is one that is directed at achieving a final composition of recycled carpet scrap where the level of calcium carbonate is above 40.0 wt % per square yard of carpet scrap, and preferably, falls in the range of above 40.0 wt % to 90.0 wt % per square yard of carpet scrap. More preferably, the level of calcium carbonate in the recycled carpet scrap herein falls in the range of 55.0-85.0 wt % per yard. Most preferably, the level of calcium carbonate is adjusted to be at a level of 55.0-65.0 wt % per yard and 75.0-85.0 wt % per yard of carpet scrap.

The carpet may be woven, knotted, needle felted, tufted, hooked, exhibit a flat weave, or have a combination thereof. The carpet may be constructed of backing fibers forming one or more backing layers, face fibers extending from the backing layer, which may form a pile, and a binder deposited on a surface of the backing layer opposing the surface from which the face fibers extend. As noted above, the carpet may include the use of the indicated polymer materials for the face fibers/backing. The binder may include a number of polymer materials, such as latex or polyurethane. The binder may be applied as a powder or liquid. Furthermore, the binding layer may include organic and inorganic fillers such as calcium carbonate and crosslinked or uncrosslinked styrene butadiene rubber and latex.

### Carpet Sorting

As carpet enters a collector's facility, there are multiple ways of sorting the incoming carpet:

1. No Sorting of the Incoming Carpet with Regard to:
a. Face Fiber Type
b. Sheared vs. Non Sheared Carpet
c. Shearable vs. Non Shearable Carpets

2. Full Sorting of:
a. Face Fiber Type and,
b. Sheared vs. Non Sheared Carpet and,
c. Shearable vs. Non Shearable Carpets

3. Sorting of Shearable vs. Non Shearable Carpets

4. Sorting of Sheared vs. Non-Sheared Carpets

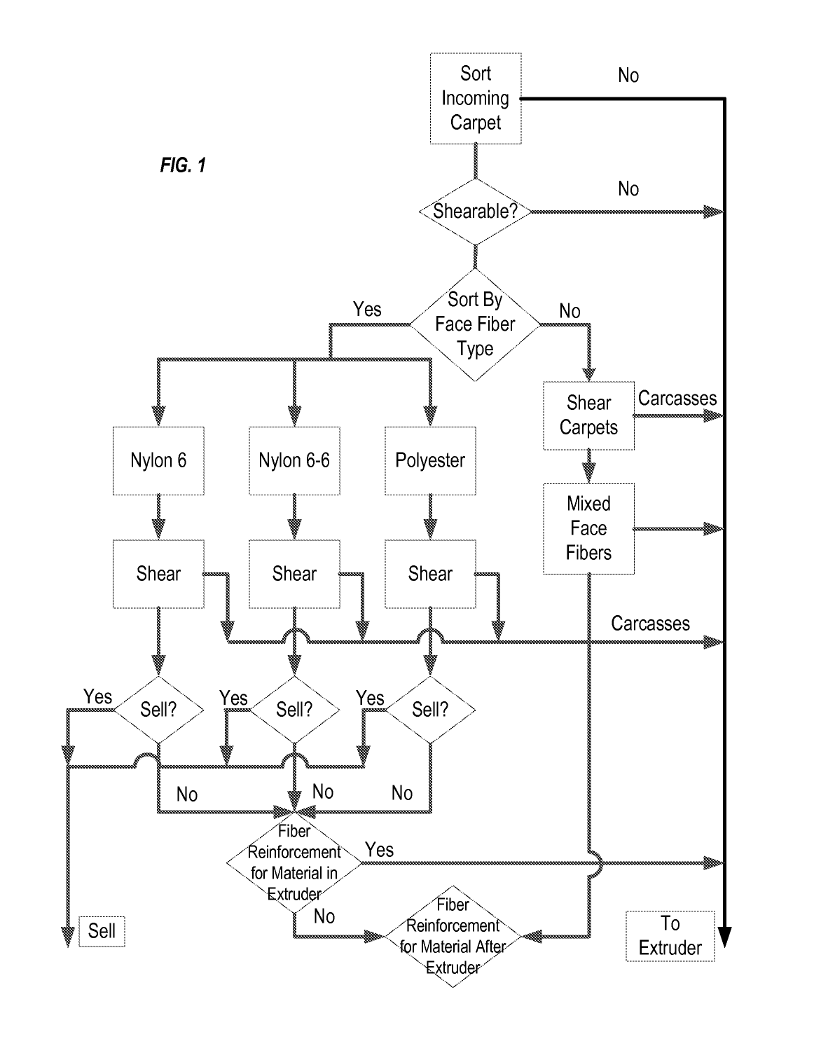

The flowchart in FIG. 1, demonstrates the process and options that may be employed herein to incorporate SBR/calcium carbonate and/or calcium carbonate to the recycled carpet scrap. Fully sorted carpet provides additional options for recycling, but the added labor and time to accomplish this can be costly.

Carpet Shearing

When residential carpet enters the recycling facility, the face fibers can be long enough to cut and utilize for several other purposes:

1. Nylon 6 and Nylon 6-6 are engineering polymers that demand a high price. These fibers can be identified, sheared, baled and sold for a substantial value. Up to 60% of the face fiber weight can be sheared from the carpet depending on the length of the face fiber. These nylon fibers can also be used as described below.

2. Polyester fibers usually have an intrinsic viscosity that is too low for recycling the material due to the oxidation and wear that has taken place over the years of use of the polyester carpet. These fibers can be:
a. Melted into the mix of other polymers for the PMAG
b. Used as a non-melted fiber reinforcement within the extruded material
c. Use as a fiber reinforcement in the batch composition of the hot mix asphalt

Presently, there are no known uses for carpet carcasses except using them as a fuel and burning them for their BTU value, or disposing of them. These carcasses do have a significant use in the recycling method of the present disclosure wherein calcium carbonate or calcium carbonate with SBR is added to the mix. This additional calcium carbonate and SBR now gives carcasses a valuable output into the process disclosed herein for all of the carpet shearers that otherwise have to scrap their carcasses. This outlet now allows this processing method to make use of carcasses as a beneficial material.

The actual increase in calcium carbonate and SBR within a residential carcass cannot be “directly” calculated, but can be tested in two different ways:

1. Employing a loss on ignition ASTM test method on the incoming carpet and carcasses will determine the residual inorganic content within the carpet which will solely be the calcium carbonate (the SBR is organic and will burn off). The amount of calcium carbonate and SBR in each carpet and carcass will be known and a formulation for the incoming material can be determined to control the calcium carbonate and/or SBR added and eventually the final PMAG product. Care must be taken with regard to calcium carbonate's decomposition temperature which will convert CaCO3 to CaO at 825 DegC.

2. Calcium carbonate/SBR content is indirectly proportional to MFI and directly proportional viscosity. An inline device designed by Dynisco is employed that measures real time melt flow index (MFI) and viscosity among other parameters and can be used to approximate the amount of calcium carbonate and SBR in the plastic melt.

A control chart with upper and lower MFI or viscosity limits is created. The MFI/viscosity within the extruder melt is tracked in real time. A feedback loop would be established such that the secondary feeder would be able to increase or decrease the feeder output depending on the MFI/viscosity. If the MFI is too high, then the secondary feeder would increase its output feed rate until the MFI returned within the upper and lower control limits set by the system. If the MFI is too low, then the secondary feeder would reduce its output feed rate until the MFI returned within the upper and lower control limits set by the system. These control limits maintain a relatively consistent amount of calcium carbonate and SBR in the extruder melt. The tighter the MFI limits, the tighter the calcium carbonate and SBR tolerance.

### Carpet Size Reduction

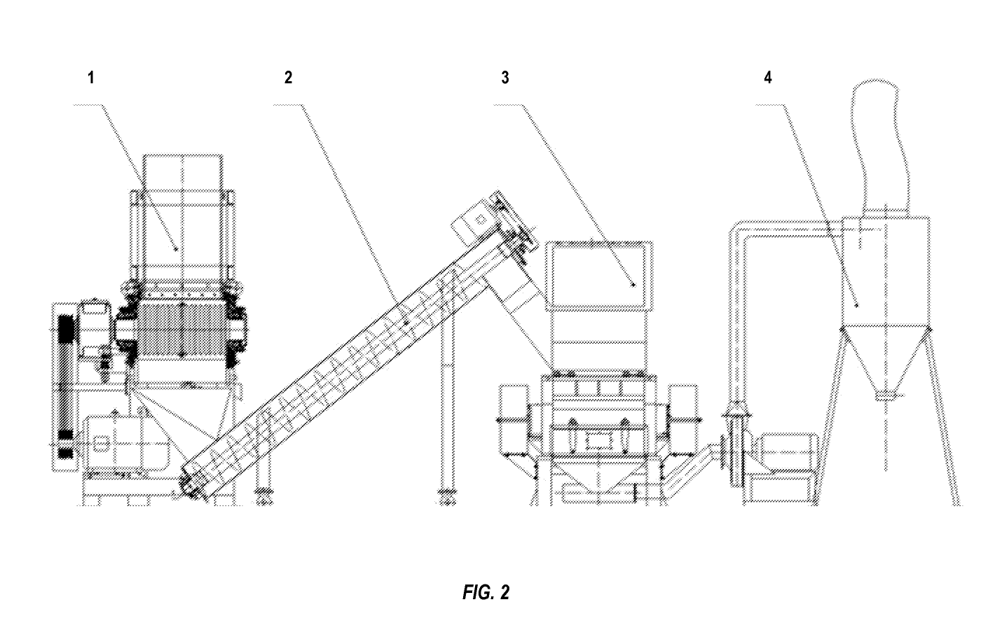

The incoming variable stream of carpet provides a large stream of unsorted carpet. After sorting occurs, if any, the carpet goes through a size reduction process of shredding and/or granulation and collection of the calcium carbonate and SBR. FIG. 2 demonstrates a typical size reduction and particulate retrieval system used in the carpet recycling industry, including a:

1. Shredder (#1)

2. Conveyer (#2)

3. Granulator (#3)

4. Air Classification System for CaCO3 & SBR Retrieval (#4)

Instead of the above size reduction method, a process may be used herein by which carpet could be cut into pieces capable of being fed directly into the extruder, which may be far more efficient and cost effective. Carpet can be cut by several methods including a:

1. Die of Any Shape

2. Water Jet

3. Laser

4. Knife assembly

The carpet would be cut into longitudinal strips in widths ranging from ½″ to 6″ or more depending on the size of the extruder feed throat. Several strips could be fed at the same time. These strips would be fed directly into a single or twin-screw extruder. This type of direct feed may eliminate the need for any shredding or grinding of the carpet prior to melt plastication. Besides cost, another potential advantage to this process is that it is difficult to shred and granulate carpet manufactured with a continuous fiber such as commercial carpet. The fiber can tangle within the size reduction machinery and cause several problems with the shredder. Feeding these types of carpets directly into the extruder eliminates any of these problems allowing for a relatively more efficient and less costly process.

The strips could also be sewn, clipped, or attached to fabricate a continuous strip of variable carpet types. The continuous strip could be wound onto a spool. The spool or spools could then be set next to the extruder providing a constant supply of carpet to the extruder potentially reducing extrusion surge and reducing overall labor. This continuous strip method could be done in a batch and/or a continuous mode where the continuous mode would have the extruder receiving carpet strips directly from the machinery that would implement the continuous strips as needed.

### Process of Melt Compounding All Types of Carpets

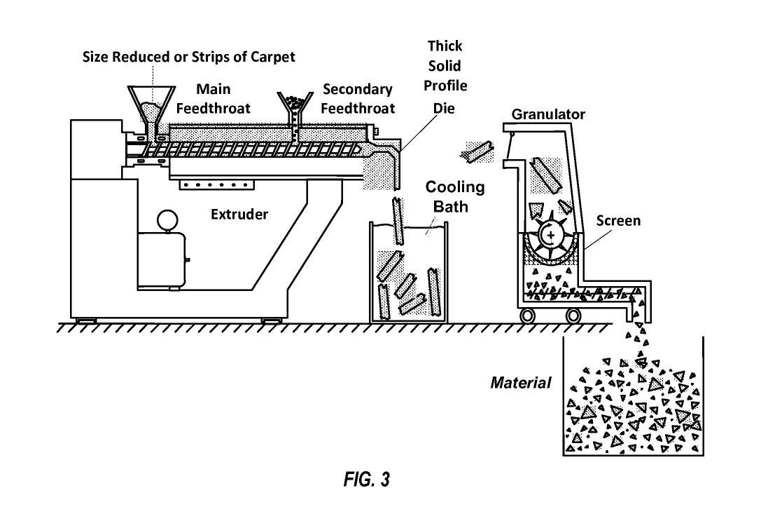

FIG. 3 exhibits a process herein for compounding mixed waste carpet. The carpet will enter the extruder at the main feedthroat without a polymer compatibilizer. Additional filler(s) will enter the extruder at the secondary feedthroat.

As mixed carpet is fed into the extruder, as noted above, the wt % of calcium carbonate will initially fall in the range of about 22.0 wt % per yard to 40.0 wt % per yard, and the level of SBR will initially fall in the range of 3.0 wt % per yard to 10.0 wt % per yard. Additional SBR containing calcium carbonate is added and/or additional calcium carbonate on its own may be added such that the final loading of calcium carbonate is increased to fall in the range of above 40.0 wt % per yard to 90.0 wt % per yard.

More specifically, the additional feed could comprise:

1. Neat Calcium Carbonate (calcium carbonate in the absence of any polymeric carrier)

2. Calcium Carbonate containing 3.0-15.0% by weight of a polymeric binder such as SBR per yard of carpet. This material can be preferably obtained from other carpet recycling operations that have no use for the material or from carpet carcasses that have higher loadings due to the shearing process.

The Polymer Modified Aggregate is preferably extruded through a relatively thick profile die having a cross-sectional area in the range of 5 cm²-50 cm², including all values and ranges therein. The material exiting the die would be cooled by water and/or air. The strips would then be put into a granulator with the appropriate screen size openings in the range of 3/16″ to ¾″, including all values and ranges therein. The aggregate that comes through the screen will be very uniform in size and have a very low surface area.

A relatively less complicated solution is contemplated to employ a twin-screw extruder with an open die configuration such that the die head is removed and chunks of PMAG are discharged directly into a water bath for cooling. The compounded material exits the open die where the size of the aggregate generated is determined by the last element on the screw profile; larger elements would produce larger sized aggregate. A kneading block element can also be substituted for the final element in the twin screw profile producing a different shape aggregate, again with far more surface area than material that is homogeneously grinded.

An additional advantage to this method is that the aggregate shape is not round but relatively angular, thereby increasing the surface area of the aggregate for a given volume of aggregate. Increased surface area allows for increased binding between the polymer modified aggregate and the asphalt binder that the aggregate will be mixed into. This will provide a higher tensile strength within the final matrix.

Reinforcement of the Polymer Modified Aggregate

In working with mixed waste polymers in carpets, all of the polymers can be melted, though there is a need to watch for degradation of polymers that melt at lower temperatures. Table 4 provides the approximate melt temperatures of some of the polymers that may be encountered in a stream of mixed waste carpet found in a recycling process, though other polymers could exist.

TABLE 4
Approx. Melt Temp. Of Each Carpet Polymer

| | | |
|---|---|---|
| Polyethylene (LD) | Backing | 266 Deg F., 130 Deg C. |
| PVC | Backing | 285 Deg F., 140 Deg C. |
| Polypropylene | Backing | 275 Deg F., 135 Deg C. |
| Nylon 6 | Face Fiber | 427 Deg F., 220 Deg C. |
| PET | Face Fiber | 500 Deg F., 260 Deg C. |
| Nylon 6-6 | Face Fiber | 516 Deg F., 267 Deg C. |

Because of the difference between backing fiber and face fiber melt temperatures, the opportunity exists to melt some polymers and leave others in fibrous form. If the screw or screw profile is designed properly and the shear and heat are controlled, the higher melting polymers such as nylon 6, nylon 6-6 and polyester could remain in fibrous form acting as reinforcement within the final product.

In a sorting method where shearable carpets would be separated from non-shearable carpets, the face fibers would not be identified or sorted. The reinforcement could then include face fibers manufactured from:

1. Nylon-6 2. Nylon 6-6 3. Polyester 4. Acrylic

The mixed polymer fibers could be used as follows:

1. Design the screw profile so that the shear and heat profiles are controlled such that the above polymers would remain in fibrous form acting as reinforcement within the final product.

2. Fibers could be introduced into a downstream feeder on the extruder to act as reinforcement for the Polymer Modified Aggregate, though the residence time and shear would have to be low enough so that the fibers would not melt

3. Fibers could be added to the final matrix of Polymer Modified Aggregate, asphalt, stone, and sand which is the asphalt batch mix. This will be discussed later in this disclosure.

Employing a full carpet sorting method, the shearable carpet would be separated from the non-shearable carpet. The shearable carpet would be sorted by carpet fiber type. Each carpet fiber type would be sheared and kept separate for a variety of purposes including:

1. Sale of the fiber

2. Pelletization of the fiber

3. Sorted fibers could be introduced into a downstream feeder on the extruder to act as reinforcement for the Polymer Modified Aggregate, though the residence time and shear would have to be low enough so that the fibers would not melt

4. Sorted fibers could be added to the final matrix of Polymer Modified Aggregate, asphalt stone, and sand.

The sheared and non-sheared carpets would then go through the identical cutting and compounding processes.

### Calcium Carbonate and SBR

As filler content increases in percentage, the polymers in the carpet scrap do not come into contact with each other as frequently. Therefore the filler may insert between the polymer chains allowing for the mixture to provide overall thermoplastic character with reduced phase separation. The organic or inorganic filler could be one of many inorganic compounds including calcium carbonate that preferably range in size from 10 nm to 1,000 μm, including all values and ranges therein. As long as the organic/inorganic filler(s) can be compounded uniformly within the polymer melt, the organic/inorganic filler(s) could be used as an inert filler that does not react with the polymers present.

A reactive filler that reacts with one or more of the polymer materials may optionally be present. Some examples of inorganic fillers include but are not limited to: (1) Aluminum Oxide, (2) Iron Chloride, (3) Boric Acid, (4) Calcium Oxide, (5) Soda Lime, (6) Ammonium Chloride, (7) Titanium Dioxide, (8) Silicon Dioxide, (9) Manganese Sulfate, (10) Calcium Chloride, (11)

Sodium Bicarbonate, (12) Copper Sulfate, (13) Potassium Hydroxide, (14) Zinc Oxide, (15) Magnesium Phosphate (16) any Fuel Ash and (16) Sodium Chloride among many other solid and liquid inorganic compounds.

### Polymer Modified Aggregate in a Hot Mix Asphalt (HMA) Application

The product of the outlined process above is an aggregate that will be used in a hot mix asphalt application. A typical hot mix asphalt contains mineral (e.g. stone) aggregate, asphalt binder and sand. It is contemplated herein that such HMA may now include 1.0% by volume to 50.0% by volume the PMAG herein, which as noted, includes elevated levels of calcium carbonate.

More specifically, as the asphalt batch is manufactured, stone aggregate, sand, and asphalt binder are mixed together. The percent of stone aggregate removed by volume is preferably replaced by the same volume of PMAG. One of the reason's volume is used is that PMAG weighs far less than stone aggregate with a specific gravity of around 2.0. This lightweight aggregate is contemplated to have applications on bridges, overpasses and structures that need to have a lower stress on the underlying structure.

### HMA Background

The Hot Mix Asphalt (HMA) industry is a major user of mineral aggregates. In the past, a number of different types of waste materials such as granulated rubber and polymers have been used for recycling of waste materials and enhancement of HMA properties. Polymer Modified Aggregate (PMAG) has the potential of being used as a partial replacement of mineral aggregates (i.e. the stone) in HMA applications. It is contemplated that the PMAG will enhance the durability of HMA, such that the use of PMAG can reduce the use of mineral aggregate and hence help in conservation of natural resources as well as in recycling waste carpet. Replacement of mineral aggregate by PMAG is also contemplated to result in the use of several hundred thousand tons of PMAG, and hence a reuse of a significant amount of waste carpet.

The present disclosure herein is therefore, in summary, one that offers one or more of the following benefits to the carpet recycling industry: (1) ability to increase the loadings of calcium carbonate and/or SBR containing calcium carbonate into existing carpet scrap; (2) ability to recycle and reprocess carpet carcasses; (3) ability to approximate the levels of calcium carbonate and SBR in an extruder via melt index evaluations; (4) use of statistical process control to maintain levels of calcium carbonate and/or SBR within desired limits; (5) feeding of carpet via one or more strips directly into the feedthrough of the extruder; (6) open die discharge to produce chunks of material that is angular and has a significantly high surface area than ground PMAG; (7) keeping the single or mixed fibers that are in the extruder in fibrous form by controlling the shear and temperature profile so that the fibers do not melt (predominantly nylon-6,6 and polyester); (8) use of mixed carpet fibers (nylon-6, nylon-6,6 and polyester) in a final HMA matrix.

1. A method for increasing the levels of filler in carpet scrap comprising:
(a) supplying carpet scrap containing a polymer backing, polymeric face fibers and a binder containing calcium carbonate, wherein the level of calcium carbonate is present at a level of up to 40.0% by weight per square yard of carpet scrap;
(b) introducing said carpet scrap into melt processing equipment and adding additional calcium carbonate, wherein said additional calcium carbonate is supplied as either neat calcium carbonate or calcium carbonate dispersed in a polymeric binder;
(c) melt compounding the mixture in (b) and forming an extrudate of recycled carpet scrap containing greater than 40.0% by weight of calcium carbonate per square yard of carpet scrap to 90.0% by weight of calcium carbonate per square yard of carpet scrap.

2. The method of claim 1 wherein the extrudate of recycled carpet contains 55.0% by weight of calcium carbonate per square yard of carpet to 85.0% by weight of calcium carbonate per square yard of carpet.

3. The method of claim 1 wherein said carpet comprises a carpet containing face fibers and a backing wherein up to 60.0% by weight of the face fibers have been removed.

4. The method of claim 1 wherein said binder in said carpet comprises styrene-butadiene polymer.

5. The method of claim 1 wherein said calcium carbonate dispersed in a polymeric binder comprises calcium carbonate dispersed in styrene-butadiene polymer.

6. The method of claim 1 wherein said polymeric backing and polymer face fibers comprises a plurality of polymers each having a respective melting point (Tm) and wherein said melt processing is carried out at a temperature such that one or more of said plurality of polymers are not heated above their respective melting point.

7. The method of claim 1 wherein said extrudate formed in step (c) is combined with hot mix asphalt, wherein said hot mix asphalt contains mineral aggregate, asphalt binder and sand.

8. The method of claim 7 wherein said hot mix asphalt comprises 1.0% by volume to 50.0% by volume of said extrudate.

9. The method of claim 1 wherein said melt processing equipment includes a device for measuring real time melt flow index values of said extrudate and determining the level of calcium carbonate in said extrudate.

10. The method of claim 1 wherein said melt processing equipment comprises an extruder.

11. The method of claim 1 wherein said carpet supplied in step (a) comprises a carpet carcass comprising face fibers and a polymeric backing wherein up to 60.0% by weight of said face fibers have been removed.

12. The method of claim 10 wherein said extruder includes an open-die configuration wherein said extrudate is discharged directly from said open die.
